(19) United States
(12) Patent Application Publication
(10) Pub. No.: US 2025/0374153 A1
(43) Pub. Date: Dec. 4, 2025

(54) CONFIDENCE-BASED ADVANCED TRAJECTORY PREDICTION

(71) Applicant: Nokia Technologies Oy, Espoo (FI)

(72) Inventors: Janne ALI-TOLPPA, Pirkkala (FI); Aliye KAYA, Chatham, NJ (US); Anna PANTELIDOU, Massy (FR); Alperen GUNDOGAN, Munich (DE); Amaanat ALI, Espoo (FI); Sina KHATIBI, Munich (DE)

(21) Appl. No.: 18/877,248

(22) PCT Filed: Jun. 20, 2022
(86) PCT No.: PCT/US2022/034153

§ 371 Date: Dec. 19, 2024

(51) Int. Cl. H04W 36/32; H04L 41/16; H04W 4/029; H04W 36/00

(52) U.S. Cl. CPC H04W 36/324; H04L 41/16; H04W 36/008375; H04W 4/029

(57) ABSTRACT

An apparatus includes at least one processor; and at least one memory including computer program code; wherein the at least one memory and the computer program code are configured to, with the at least one processor, cause the apparatus at least to: receive as input to a machine learning model a sequence of past serving locations of a user equipment; determine, using the machine learning model, a vector of confidences for predicted next locations of the user equipment; create at least one fork for at least one predicted next location of the predicted next locations having a confidence that exceeds a forking threshold; and determine iteratively a plurality of next locations of the user equipment, using as input the at least one predicted next location having the confidence that exceeds the forking threshold.

### TECHNICAL FIELD

The examples and non-limiting example embodiments relate generally to communications and, more particularly, to confidence-based advanced trajectory prediction.

### BACKGROUND

It is known to determine a position of a user equipment in a wireless communication network.

### SUMMARY

In accordance with an aspect, an apparatus includes at least one processor; and at least one memory including computer program code; wherein the at least one memory and the computer program code are configured to, with the at least one processor, cause the apparatus at least to: receive as input to a machine learning model a sequence of past serving locations of a user equipment; determine, using the machine learning model, a vector of confidences for predicted next locations of the user equipment; create at least one fork for at least one predicted next location of the predicted next locations having a confidence that exceeds a forking threshold; and determine iteratively a plurality of next locations of the user equipment, using as input the at least one predicted next location having the confidence that exceeds the forking threshold.

In accordance with an aspect, an apparatus includes at least one processor; and at least one memory including computer program code; wherein the at least one memory and the computer program code are configured to, with the at least one processor, cause the apparatus at least to: receive a handover request from a network node; receive, with the handover request from the network node, a predicted confidence that a user equipment follows a trajectory; and determine, based on the received predicted confidence and one or more predicted trajectory forks, whether to perform at least one of admission control, contention-free random access, or resource allocation.

In accordance with an aspect, an apparatus includes at least one processor; and at least one memory including computer program code; wherein the at least one memory and the computer program code are configured to, with the at least one processor, cause the apparatus at least to: form a trajectory prediction information element configured to store information used to predict a trajectory of a user equipment among a set of at least two candidate trajectories; wherein the at least two candidate trajectories are determined iteratively using as input to a machine learning model at least one predicted next location having a confidence that exceeds a forking threshold, and with creating at least one fork for the at least one predicted next location having the confidence that exceeds the forking threshold; form a trajectory information element configured to store information related to the trajectory of the user equipment; wherein the trajectory prediction information element is composed of at least one of the trajectory information element; and form a trajectory node information element that represents at least one location in the trajectory of the user equipment.

In accordance with an aspect, a method includes receiving as input to a machine learning model a sequence of past serving locations of a user equipment; determining, using the machine learning model, a vector of confidences for predicted next locations of the user equipment; creating at least one fork for at least one predicted next location of the predicted next locations having a confidence that exceeds a forking threshold; and determining iteratively a plurality of next locations of the user equipment, using as input the at least one predicted next location having the confidence that exceeds the forking threshold.

In accordance with an aspect, a method includes receiving a handover request from a network node; receiving, with the handover request from the network node, a predicted confidence that a user equipment follows a trajectory; and determining, based on the received predicted confidence and one or more predicted trajectory forks, whether to perform at least one of admission control, contention-free random access, or resource allocation.

In accordance with an aspect, a method includes forming a trajectory prediction information element configured to store information used to predict a trajectory of a user equipment among a set of at least two candidate trajectories; wherein the at least two candidate trajectories are determined iteratively using as input to a machine learning model at least one predicted next location having a confidence that exceeds a forking threshold, and with creating at least one fork for the at least one predicted next location having the confidence that exceeds the forking threshold; forming a trajectory information element configured to store information related to the trajectory of the user equipment; wherein the trajectory prediction information element is composed of at least one of the trajectory information element; and forming a trajectory node information element that represents at least one location in the trajectory of the user equipment.

In accordance with an aspect, an apparatus includes means for receiving as input to a machine learning model a sequence of past serving locations of a user equipment; means for determining, using the machine learning model, a vector of confidences for predicted next locations of the user equipment; means for creating at least one fork for at least one predicted next location of the predicted next locations having a confidence that exceeds a forking threshold; and means for determining iteratively a plurality of next locations of the user equipment, using as input the at least one predicted next location having the confidence that exceeds the forking threshold.

In accordance with an aspect, an apparatus includes means for receiving a handover request from a network node; means for receiving, with the handover request from the network node, a predicted confidence that a user equipment follows a trajectory; and means for determining, based on the received predicted confidence and one or more predicted trajectory forks, whether to perform at least one of admission control, contention-free random access, or resource allocation.

In accordance with an aspect, an apparatus includes means for forming a trajectory prediction information element configured to store information used to predict a trajectory of a user equipment among a set of at least two candidate trajectories; wherein the at least two candidate trajectories are determined iteratively using as input to a machine learning model at least one predicted next location having a confidence that exceeds a forking threshold, and with creating at least one fork for the at least one predicted next location having the confidence that exceeds the forking threshold; means for forming a trajectory information element configured to store information related to the trajectory of the user equipment; wherein the trajectory prediction information element is composed of at least one of the trajectory information element; and means for forming a trajectory node information element that represents at least one location in the trajectory of the user equipment.

In accordance with an aspect, a non-transitory program storage device readable by a machine, tangibly embodying a program of instructions executable with the machine for performing operations is described and provided, the operations including: receiving as input to a machine learning model a sequence of past serving locations of a user equipment; determining, using the machine learning model, a vector of confidences for predicted next locations of the user equipment; creating at least one fork for at least one predicted next location of the predicted next locations having a confidence that exceeds a forking threshold; and determining iteratively a plurality of next locations of the user equipment, using as input the at least one predicted next location having the confidence that exceeds the forking threshold.

In accordance with an aspect, a non-transitory program storage device readable by a machine, tangibly embodying a program of instructions executable with the machine for performing operations is described and provided, the operations including: receiving a handover request from a network node; receiving, with the handover request from the network node, a predicted confidence that a user equipment follows a trajectory; and determining, based on the received predicted confidence and one or more predicted trajectory forks, whether to perform at least one of admission control, contention-free random access, or resource allocation.

In accordance with an aspect, a non-transitory program storage device readable by a machine, tangibly embodying a program of instructions executable with the machine for performing operations is described and provided, the operations including: forming a trajectory prediction information element configured to store information used to predict a trajectory of a user equipment among a set of at least two candidate trajectories; wherein the at least two candidate trajectories are determined iteratively using as input to a machine learning model at least one predicted next location having a confidence that exceeds a forking threshold, and with creating at least one fork for the at least one predicted next location having the confidence that exceeds the forking threshold; forming a trajectory information element configured to store information related to the trajectory of the user equipment; wherein the trajectory prediction information element is composed of at least one of the trajectory information element; and forming a trajectory node information element that represents at least one location in the trajectory of the user equipment.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an example of UE trajectory prediction.

FIG. 3 shows an example beam/transmission prediction approach.

FIG. 4 illustrates the difficulty of predicting an exact trajectory of a UE.

FIG. 5 shows prediction accuracy if K most likely beams are predicted and one of them is correct.

FIG. 6 shows reliability of prediction.

FIG. 7 illustrates beam index prediction.

FIG. 8 shows creating forking trajectory predictions for beam index prediction.

FIG. 9 shows an example presenting a more complex scenario with forking and overall confidences.

FIG. 10 shows Table 3, or the TrajectoryPredictionFunction new parameters

FIG. 11 shows information elements for forking trajectory prediction as a class diagram.

FIG. 12 shows Table 4, or attributes of an example TrajectoryPrediction IE.

FIG. 13 shows Table 5, or attributes of an example Trajectory IE.

FIG. 14 shows a tree node representing one location in a trajectory.

FIG. 15 shows use of the examples described herein in CHO preparation, based partially on 3GPP TS 38.300 FIG. 9.2.3.4.2-1.

FIG. 16 is an example apparatus configured to implement the examples described herein.

FIG. 17 shows a representation of an example of non-volatile memory media.

FIG. 18 is a method to perform the examples described herein.

FIG. 19 is a method to perform the examples described herein.

FIG. 20 is a method to perform the examples described herein.

### DETAILED DESCRIPTION OF EXAMPLE EMBODIMENTS

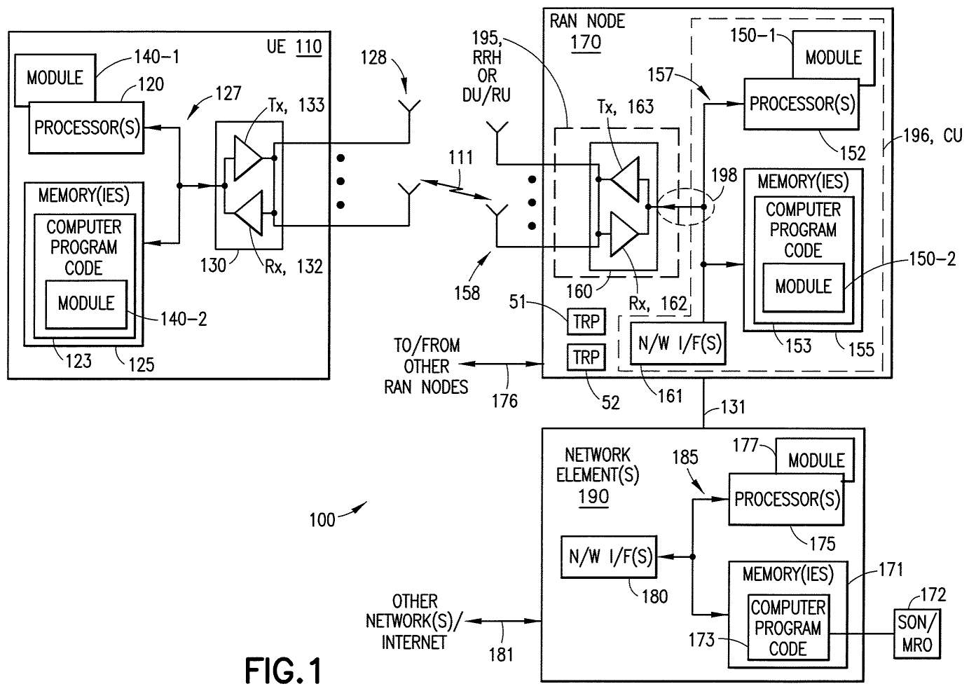

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1. The TRPs 51 and 52 may form part of the components of transceiver 160.

A relay node in NR is called an integrated access and backhaul node. A mobile termination part of the IAB node facilitates the backhaul (parent link) connection. The mobile termination part is the functionality which carries UE functionalities. The distributed unit part of the IAB node facilitates the so called access link (child link) connections (i.e. for access link UEs, and backhaul for other IAB nodes, in the case of multi-hop IAB). The distributed unit part is responsible for certain base station functionalities. The IAB scenario may follow a split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and both 5G and LTE functions may be supported.

The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The one or more network elements 190 comprises a module 177 that may include Near-Real-Time RIC functionality. Computer program code 173 may include Near-Real-Time RIC functionality. Module 150-1 and/or module 150-2 may include Near-Real-Time RIC functionality.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV.

UE 110, RAN node 170, and/or network element(s) 190, (and associated memories, computer program code and modules) may be configured to implement (e.g. in part) the methods described herein, including confidence-based advanced trajectory prediction. Thus, computer program code 123, module 140-1, module 140-2, and other elements/features shown in FIG. 1 of UE 110 may implement user equipment related aspects of the methods described herein. Computer program code 153, module 150-1, module 150-2, and other elements/features shown in FIG. 1 of RAN node 170 may implement gNB/TRP related aspects of the methods described herein. Computer program code 173 and other elements/features shown in FIG. 1 of network element(s) 190 may be configured to implement network element related aspects of the methods described herein.

Having thus introduced a suitable but non-limiting technical context for the practice of the example embodiments, the example embodiments are now described with greater specificity.

The examples described herein are related to 5G New Radio, and in particular to the Multi-RAT Mobility (MRM) concept targeted for 3GPP Rel-18 and beyond which enables and improves mobility/cell-change/CHO preparations in a RAN by trajectory prediction of the UE. The base station improves the selection of the candidate beams/cells for CHO to the most likely ones by trajectory prediction of the UE. The base station determines the next/second beam/cell which the UE is most likely connecting to and reduces the number of CHO preparation procedures to those beams/cells which are most likely connecting to the UE later on.

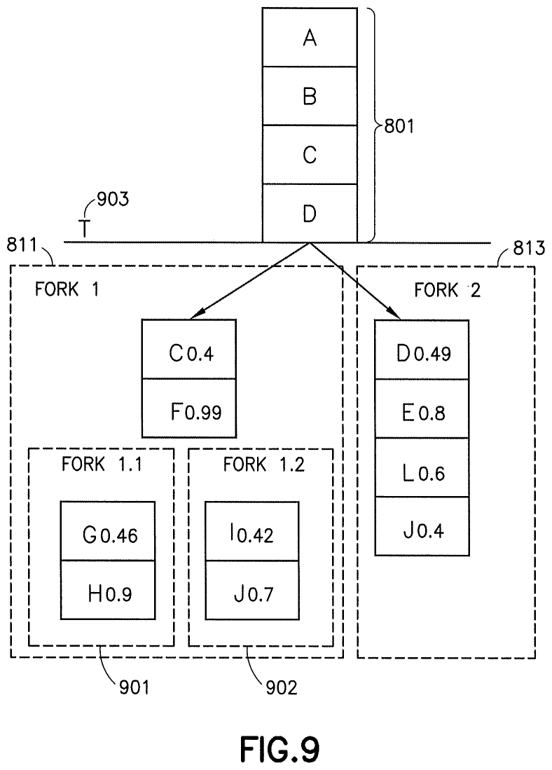

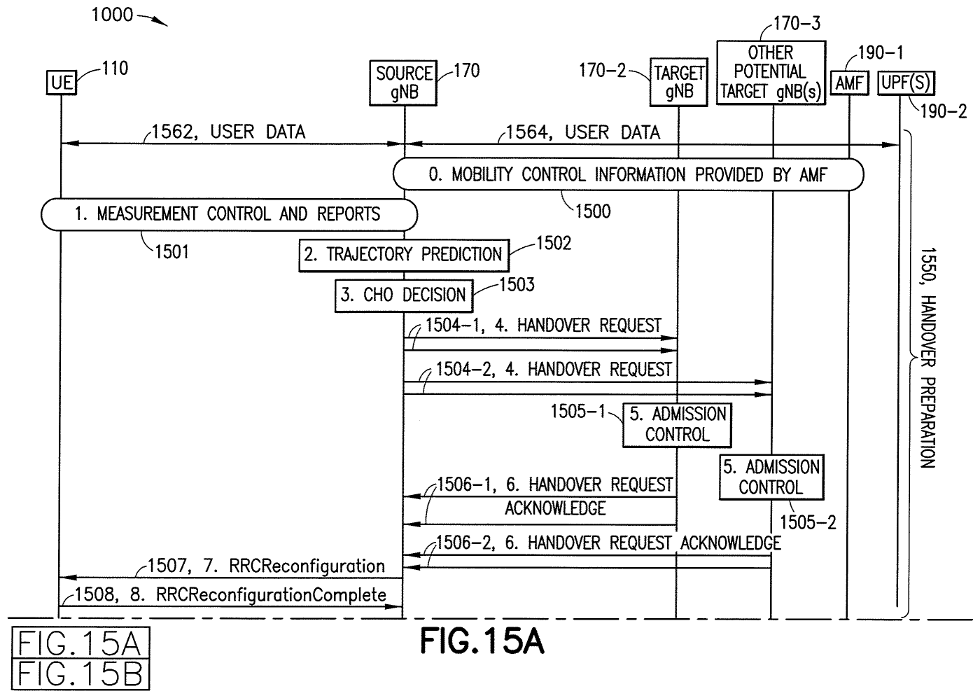

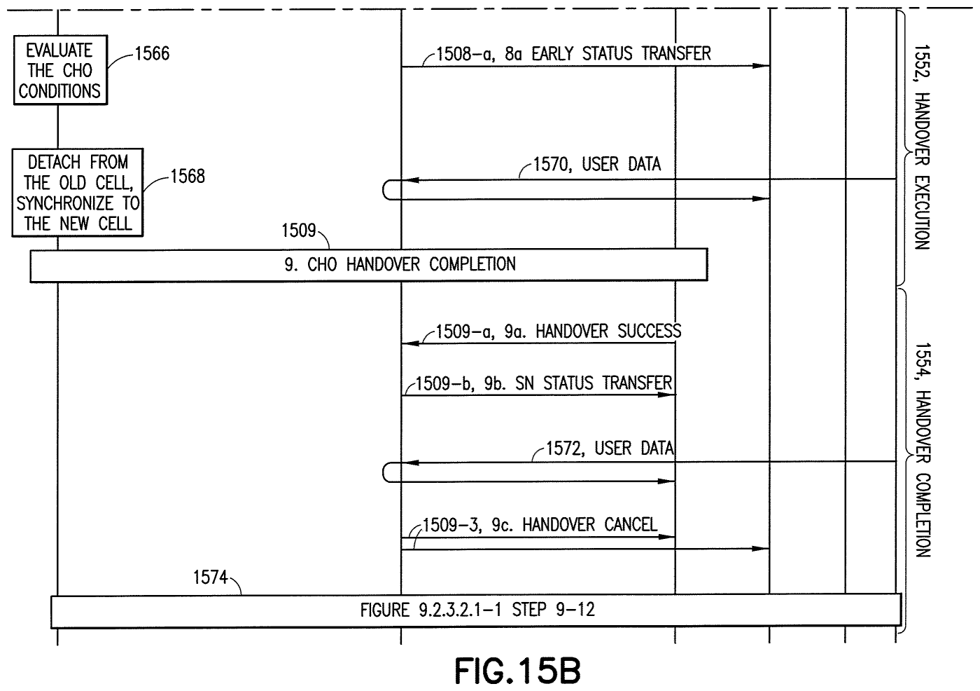

TS 38.300 section 9.2.3.4.2 provides a basis for the CHO preparation procedure (e.g. FIG. 9.2.3.4.2-1, which serves as a reference for FIG. 15 herein). The trajectory prediction use case is discussed in the 3GPP TSG-RAN WG3 Meeting #116-e, with planned enhancements. The CHO preparation procedure, including that for Rel-17 3GPP, may be enhanced/improved by method described herein.

To predict the second/next beams/cells which the UE is most likely going to connect to, the source base station determines a confidence level for a set of neighboring cells and selects among those the ones with the highest score (i.e., above a threshold) and performs for each selected cell/beam the trajectory prediction determination with the same input including those neighbor beams/cells with the high score to obtain the trajectory prediction of the UE including the second next beam/cell.

### UE Trajectory Prediction

UE trajectory prediction is discussed in 3GPP RAN3 with the intention of adding it to the 3GPP TR 37.817 “Study on enhancement for Data Collection for NR and EN-DC”. Refer to 3GPP TSG-RAN WG3 Meeting #114bis-e, R3-21xxxx.

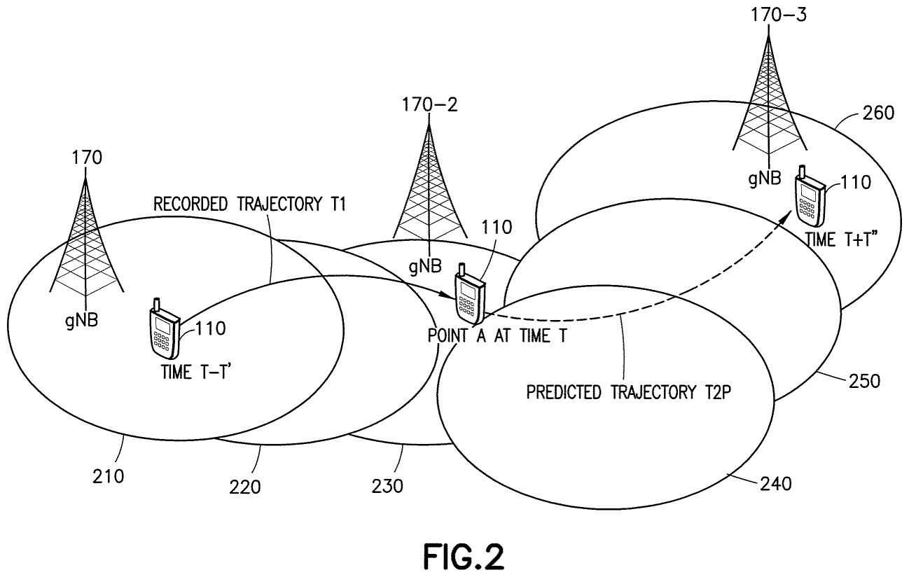

UE trajectory prediction may include latitude, longitude, altitude, and/or the cell ID of the UE over a future period of time. Additionally, a beam ID may be added. The beam ID may be a factor in optimizing early data forwarding, especially for CHO. To produce UE trajectory prediction in the output an NG-RAN node needs to train an ML model. With reference to FIG. 2, model inference of a trajectory prediction ML algorithm may need in the input the following information: a) the observed UE's trajectory T1 until the UE reaches a point A, which may comprise a list of visited cells (e.g. 210, 220, 230) on which the UE camped on in idle mode, or to which the UE was connected, and b) radio measurements reported by the UE or performed by the network.

The output of model inference corresponds to prediction information related to a trajectory which is denoted by T2p in FIG. 2. The UE 110 is predicted to visit cells 240, 250, and 260. One or more of cells 210, 220, 230, 240, 250, and 260 is hosted by gNB 170, gNB 170-2, and gNB 170-3.

### L1/L2 Beam Prediction and Predictive L3 Mobility

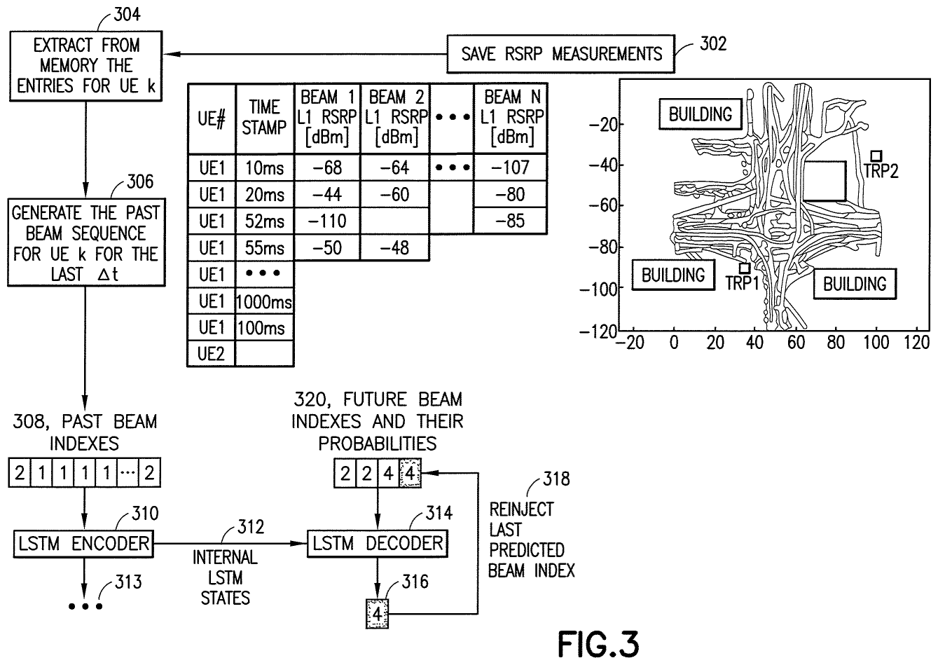

In “Deep Learning-based Predictive Beam Management for 5G mmWave Systems”, Özge Kaya, Harish Viswanathan, Wireless Communications and Networking Conference (WCNC), 2021, Nanjing, China (“Deep Learning”), a method to accurately predict in advance the best serving beams and transmission points as users move through the network and thereby eliminate the need for frequent measurement reporting is shown. The prediction approach applies deep learning techniques like that used in natural language processing (NLP) for translation/sentence completion tasks, i.e. a long-short term memory (LSTM) recurrent neural network (RNN), to the problem of predicting the best serving beams and probabilities. The prediction strategy in “Deep Learning” could be applied both to L1 beam prediction and handover prediction based on L3 RSRP. The input the neural network is the beams which served the UE in the past in equidistant time intervals and the output is a trajectory of beam probabilities for the future time window Δt, in equidistant time intervals. FIG. 3 shows an overview of the approach.

With reference to FIG. 3, at 302 RSRP measurements are saved. As shown in FIG. 2, L1-RSRP beam measurements are saved for different time stamps for the UEs, including UE 1 and UE 2. At 304, the measurement entries for UE k are extracted from memory. At 306, the past beam sequence for UE k for the last Δt is generated. The past beam indexes 308 are provided to the LSTM encoder 310. The LSTM encoder 310 provides internal LSTM states 312 to the LSTM decoder 314, and provides output elsewhere in the system (313). The LSTM decoder 314 predicts with a probability a future beam index 316. At 318, the last predicted beam index with probability is reinjected into a list 320 of future beam indexes and their probabilities.

The serving beam index prediction is at the same time a type of trajectory prediction. A predicted next beam may not belong to the current serving cell, in which case an inter-cell handover or a conditional handover (CHO) may be prepared.

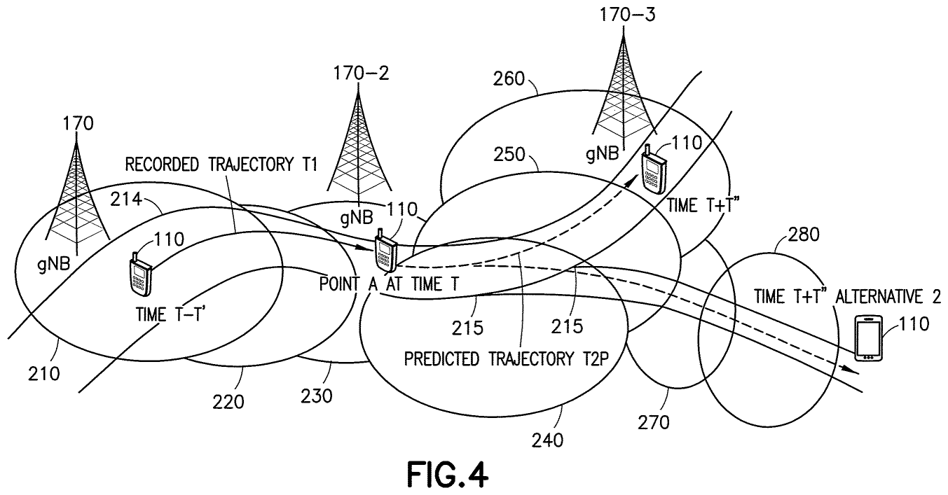

Consider the modified 3GPP trajectory prediction example shown in FIG. 4, where a highway 214 forks in a Y-intersection at crossroads 215. Although statistical predictions can be made, based on the percentage of UEs driving on the highway 214 that go in which direction, it may be impossible to predict this for a single UE 110. Giving a wrong prediction can be worse than no prediction at all, so predicting the most common trajectory may not be a solution for beam management, inter-cell mobility, load balancing optimization etc.

As an example, as the trajectory of the UE 110 might change over time e.g. due to intersection points on the highway, relying on the single UE trajectory prediction might lead to higher interruption time and inefficient usage of radio resources.

If it is assumed that UE 110 follows predicted trajectory T2p in FIG. 4 based on the trajectory prediction, however UE 110 follows alternative 2 in FIG. 4, then a) the cells on the path of the T2p trajectory could be prepared only with contention free random access resources (CFRA) to reduce the interruption time of the UE and as the trajectory prediction of the UE 110 was wrong, this could lead to inefficient use of limited CFRA resources at the cells, and b) the cells on the path of alternative 2 path are not informed about the UE trajectory prediction (as the prediction outputs trajectory T2p), thus they are not prepared prior (e.g. to prepare CFRA resources) for a possible handover procedure of the UE (e.g. to cells 270 and 280). This can result in the UE using only CBRA resources for handover and thus can increase interruption time.

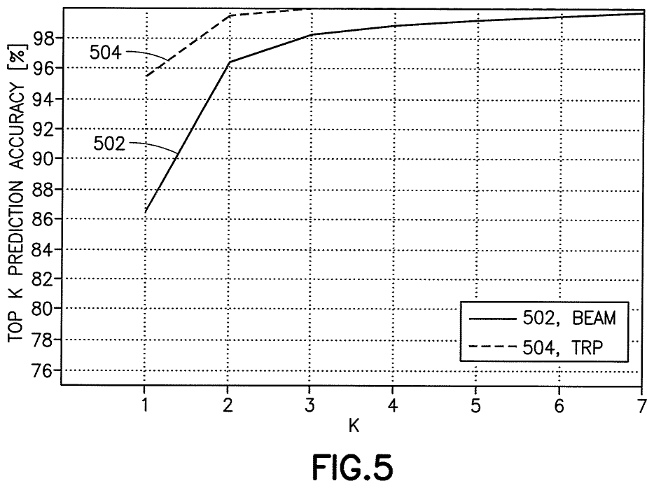

Studies with reference to “Deep Learning” and WO2020/214168 indicate that the reliability of predictions increases if more than one beam are monitored (which may belong to the same or different access points) and the network is prepared ahead for beam switching and handovers for those beams. FIG. 5 shows the prediction accuracy if the network is prepared with the most likely K beams. Plot 502 corresponds to beam, and plot 504 corresponds to TRP.

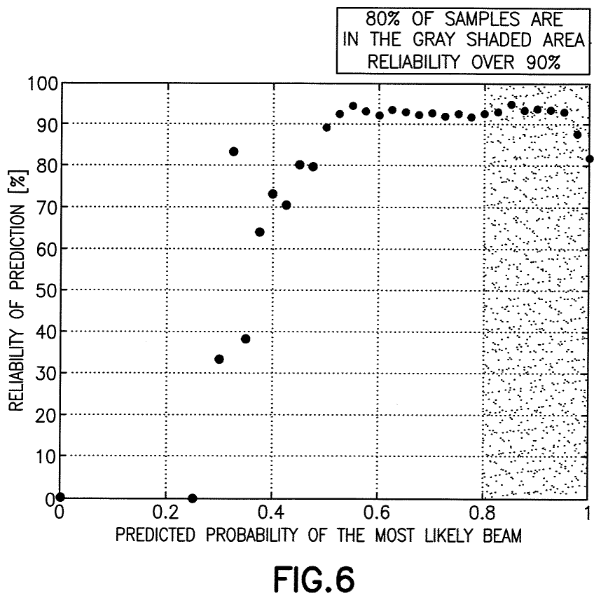

In FIG. 6 the top-2 beam prediction reliability for all the samples with similar best beam prediction probability is shown. Reliability is defined as percentage of all the samples where one of the Top-K beams is a correct prediction. FIG. 6 shows that if the best beam prediction probability is over 0.5 the reliability could be improved above the 90% mark.

So, although it may be difficult to predict the exact trajectory of the UE 110 in FIG. 4, it may be possible to predict that a UE takes either of the two trajectories, which is important information. The trajectory prediction concepts used prior to the methods described herein do not enable such predictions, and do not present a solution for how such predictions can be made.

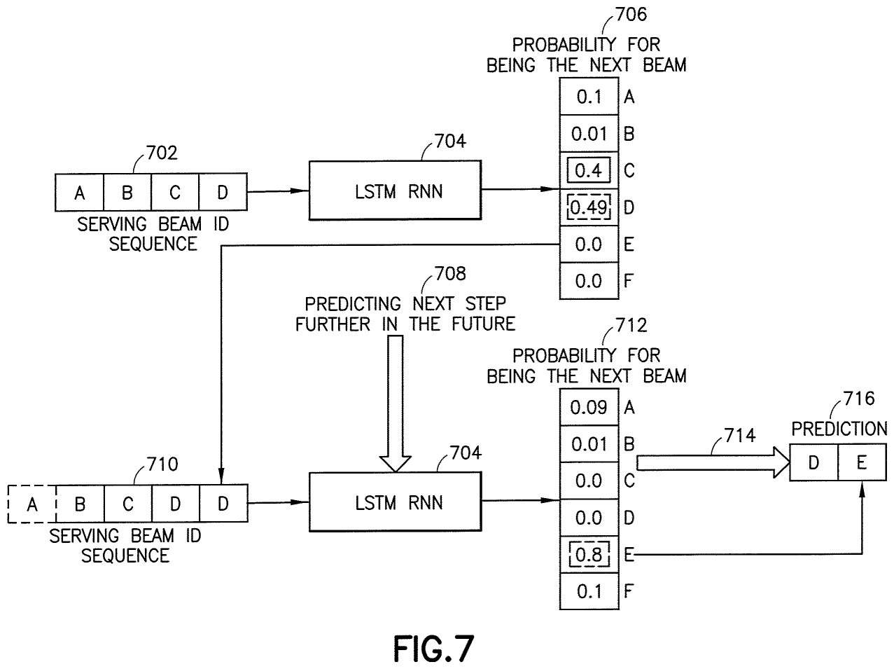

The beam prediction method and trajectory prediction presented with reference to FIG. 2 and FIG. 3 do not cover prediction of multiple likely possible trajectories individually. An example of this is shown in FIG. 7. FIG. 7 shows a long-short term memory (LSTM) recurrent neural network (RNN) model for predicting the next beam indexes using a series of past serving beam indexes (702) as the input. In this use case, which is based on the method in “Deep Learning” and WO2020/214168, the trajectory is expressed and predicted as the serving beam index probabilities. For simplicity, a simplified implementation of the method in “Deep Learning” and WO2020/214168 is presented, omitting the split to an encoder and decoder. This does not change the underlying logic, however.

The scenario covers a model covering 6 beams, with indexes A-F. The input to the model 704 is a sequence of the past serving beam indexes 702 for a UE (e.g. UE 110) and the output is a vector of confidences (706, 712) for each of the beams to be the next serving beam.

To predict (708) multiple steps ahead, the prediction probabilities of a previous step (706) is fed back in into the LSTM 704 as the last input element of the updated serving beam ID sequence 710.

In the case shown in FIG. 7, in the first prediction (706) both beams C and D have almost the same confidence for being the next serving beam. This could correspond to the crossroads 215 in FIG. 4. The method still selects (708, 714) the next potential beam with the highest confidence (in vector 706, beam D having confidence 0.49, in vector 712, beam E having confidence 0.8) and feeds it back into the LSTM 704 to predict the next step ahead. As shown, selection 714 results in prediction 716.

Although the model can predict the subsequent step (708, 714) with a high confidence, the overall predicted future sequence still has a relatively low confidence as the prediction window gets longer, because in one of the prediction steps the model was undecided between the two alternatives if there is a likelihood of forking. The existing trajectory prediction methods do not explicitly predict alternative trajectories to achieve an acceptable level of confidence and robustness in the prediction in such scenarios.

Presented herein is a method for creating several “forks” in trajectory prediction, when several trajectories have similar or significantly high confidence or likelihood. In cases like that shown in FIG. 4, it is possible to make predictions with a meaningful confidence, when the most likely trajectories instead of just one trajectory are included in the prediction.

Furthermore, described herein is a confidence-driven approach to the prediction, where confidence requirements may be used to configure the compromise between the confidence of the prediction and the number of predicted trajectories and the length of the prediction window. A high degree of confidence may only be achieved with more than one predicted trajectories. Conversely, the fewer trajectories are predicted, the more powerful a prediction is.

Described herein is a technique to improve the method presented in FIG. 7 with the following additions. Instead of a single trajectory, a trajectory prediction may be a set of possible future trajectories. The trajectories are predicted as a time series of quantized locations, later referred to as “location”. The quanta may relate, for example, to serving beam IDs, serving cell IDs, or UE coordinates quantized into pixels.

Forking criteria may be defined so that at each prediction step, where multiple likelihoods meet the forking criteria, e.g. the likelihood of the location being the next location compared to a confidence threshold, the prediction step is forked so that each predicted next location with a confidence over the threshold is fed back into the model, creating its own “fork”.

Define herein are two confidence measures, trajectory confidence C_{T} and fork confidence C_{F}.

Trajectory confidence C_{T} is the model's confidence that the UE is going to travel a given single predicted trajectory. A possible example implementation may be: C_{T}=Πᵢ₌₀^{N-1}cᵢ, where cᵢ is the prediction confidence that the UE is going to move from the i^{th} location in the trajectory to the next, and N is the prediction window length.

Fork confidence C_{F} indicates the confidence or the probability that the UE is going to travel any of the trajectories, including all (subsequent) forks. A possible example implementation may be: C_{F}=Σ_{f∈F}C_{T}(f), where F is the set of all trajectories (considering the forks) in the prediction, C_{T} (f) is the trajectory confidence of trajectory fork f. A fork confidence evaluated over the entire prediction is the prediction confidence.

Additional forking conditions may be defined. For example, a fork may be created only if the forking threshold is exceeded, and the trajectory confidence of the trajectory (fork) is above an additional forking threshold. This may be utilized to prevent additional forking, when the confidence that the UE is going to reach the forking point is not sufficiently high. A prediction window threshold may be defined to configure the prediction window length according to the achievable confidence. In this case, a trajectory (fork) is only predicted so far in the future that the trajectory confidence remains higher than the trajectory length threshold. It may be used to ensure that only trajectory predictions with a sufficient confidence are made.

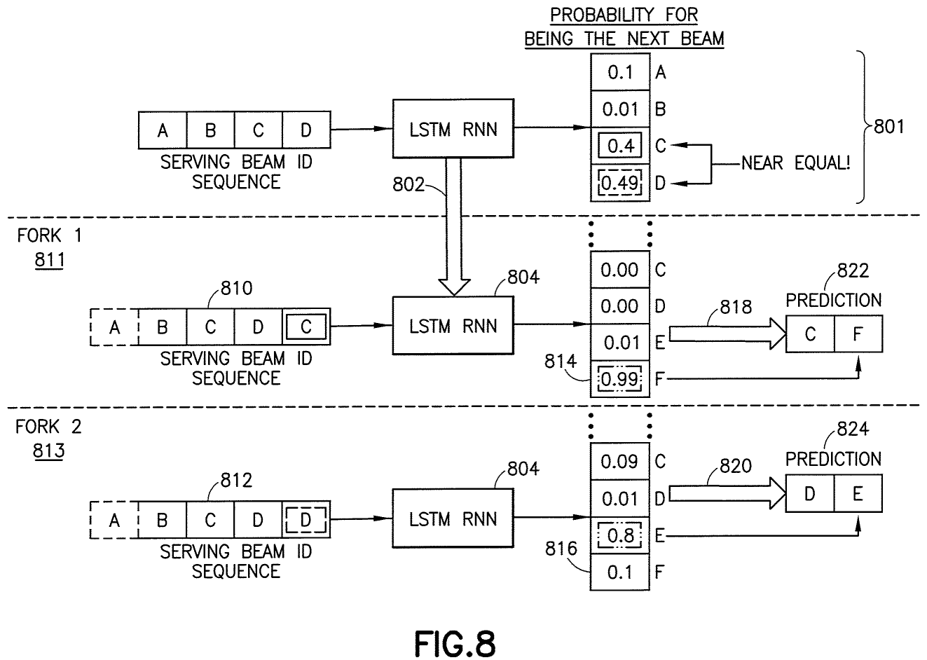

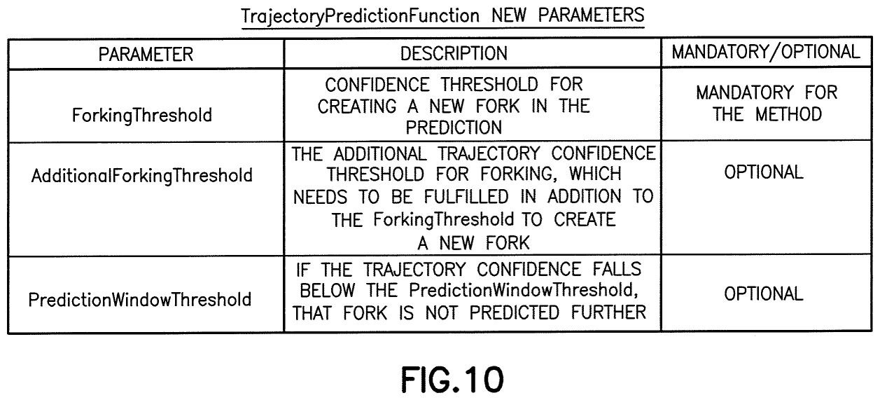

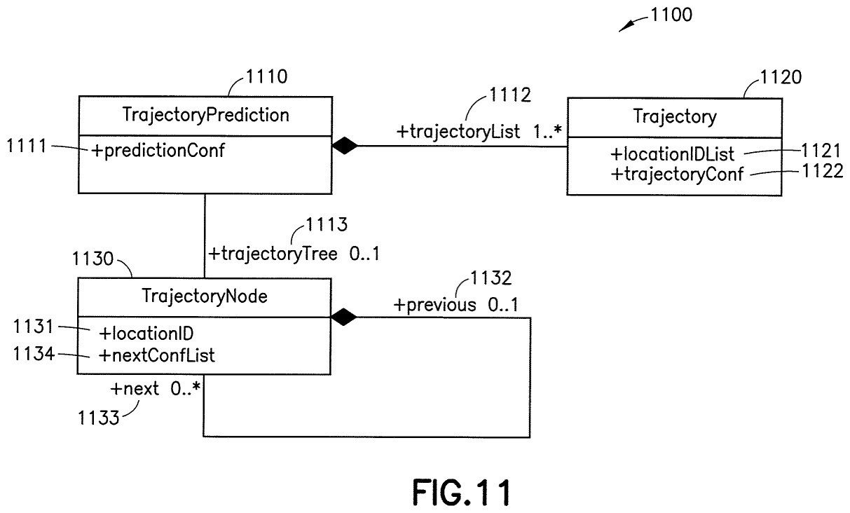

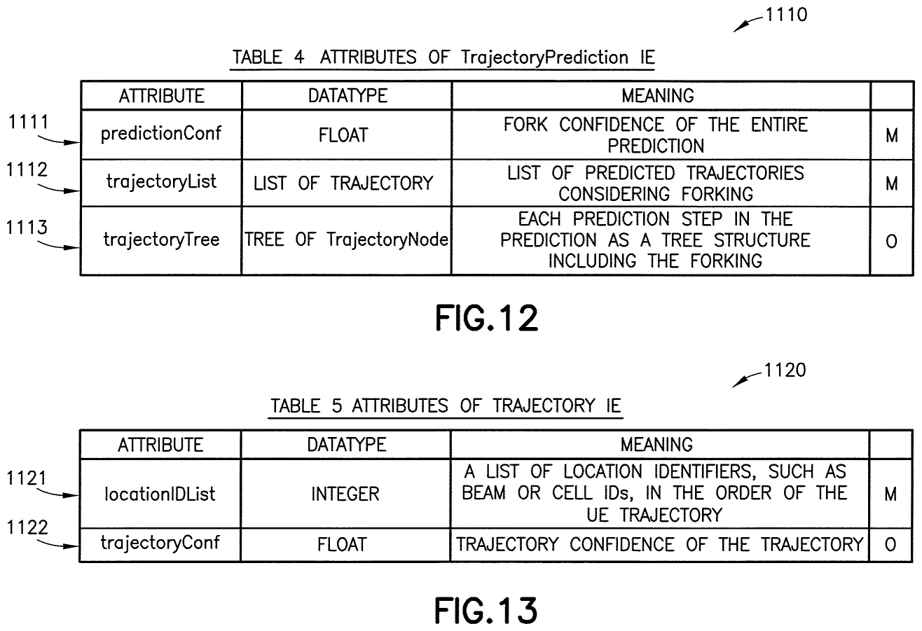

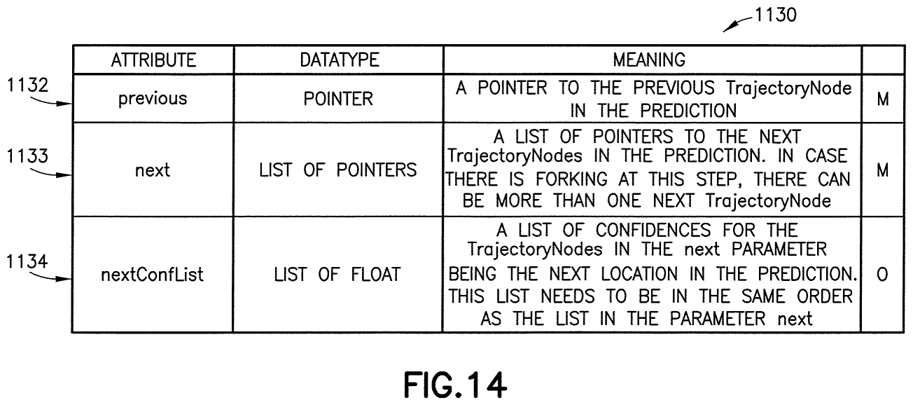

Lastly, forking criteria may be adjusted and the algorithm iterated, until a satisfactory prediction confidence is reached. It may be noted that in the solution presented with reference to FIG. 8, FIG. 9, FIG. 10, FIG. 11, FIG. 12, FIG. 13, FIG. 14, and FIG. 15, forking can be done and configured entirely at inference time and the trajectory prediction model does not need to be retrained, when the forking criteria is changed.

Based on the observed beam indexes, predicted forks may be ruled out without creating a new prediction. The forks may be used, for example, to choose which cells to prepare for a CHO or for optimizing contention free random access (CFRA) procedures. The same method can be used also when predicting cell IDs instead of serving beams.

If predicting coordinates, the locations need to be expressed as “pixels” covering a certain area that are predicted to be able to utilize the confidence threshold based forking method.

FIG. 8 shows an example of the method described herein using the same example as presented in FIG. 7. If the forking threshold is set to 0.4, for the first prediction step 802 given result 801, the model 804 is most confident that beam D is going to be the next serving beam, but it has also a confidence value higher than (or equal to) the forking threshold that beam C may alternatively be the next serving beam. In this case, a separate fork is created for both alternatives, C and D, where fork 1 811 is created for alternative C, and fork 2 813 is created for alternative D, and both are fed back into the LSTM 804 as the latest input element in their own forks 1 and 2. In fork 1 811, given serving beam ID sequence 810, beam F is predicted 818 to be the subsequent serving beam 822 with a very high confidence of 0.99. In fork 2 813, given serving beam ID sequence 812, beam E is predicted 820 to be the subsequent one 824 with a relatively lower confidence of 0.8. However, no other beam has a predicted confidence higher than the forking threshold and therefore no further forking is done. Model 804 outputs a vector of confidences 814 given serving beam ID sequence 810, and model 804 outputs a vector of confidences 816 given serving beam ID sequence 812. This example results in the following confidence values shown in Table 1.

TABLE 1
Trajectory and fork confidences in the example

| | |
|---|---|
| C_{T}(Fork 1)= | 0.4 * 0.99 = 0.396 |
| C_{T}(Fork 2)= | 0.49 * 0.8 = 0.392 |
| C_{F}(prediction)= | 0.4*0.99 + 0.49*0.8 = 0.788 |

Forking is only done, if more than one possible future location (or beam) has high-enough confidence in the prediction, i.e. exceeds the forking threshold. In this case, one of the predicted beams has such a high confidence (0.8) that no other beam has a confidence higher than the threshold and no further forking is done.

It can be noticed that although the model is predicting that it is more likely that the UE follows the Fork 2 813 (because it has higher confidence at the forking point due to D), Fork 1 811 still has a higher trajectory confidence, because the model has a much higher confidence on predicting the next beam in that trajectory, i.e., in case the UE 110 travels the trajectory in Fork 1. A fork confidence of about 80% indicates Fork 1 and 2 are the most relevant (Top 2 trajectories) which implies a high reliability of prediction that the UE eventually takes either of these paths.

FIG. 9 extends the same example with additional beams G-J and by predicting two additional steps into the future after time T 903. It demonstrates the potentially recursive nature of the forking. In this example, the earlier Fork 1 811 forks into Forks 1.1 901 and 1.2 902, while the original Fork 2 813 does not fork further. The prediction confidence of each of the next step is shown in the lower right corner. The confidence values for the predicted trajectories and forks are shown in Table 2.

TABLE 2
Confidence values for the example in FIG. 9

| | |
|---|---|
| C_{T}(Fork 1.1)= | 0.4*0.99*0.46*0.9 = 0.164 |
| C_{T}(Fork 1.2)= | 0.4*0.99*0.42*0.7 = 0.116 |
| C_{T}(Fork 2)= | 0.49*0.8*0.6*0.4 = 0.09 |
| C_{F}(Fork 1)= | 0.4*0.99*(0.46*0.9 + 0.42*0.7) = 0.280 |
| C_{F}(Fork 2)= | C_{T}(Fork 2) = 0.09 |
| C_{F}(prediction)= | C_{F}(Fork 1) + C_{F}(Fork 2) = 0.280 + 0.09 = 0.370 |

In the above example, the last step of Fork 2 may have another beam that would also be above the forking threshold, but since the trajectory confidence at that point is already below the additional forking threshold, no new fork is created. In this way, unnecessary forking is avoided in places, where the confidence of the UE 100 reaching the predicted beam is not high enough to justify the forking. Alternatively, if a prediction window threshold is configured, the Fork 2 could be predicted only 3 beams into the future to ensure sufficient confidence.

The idea of the forking is to use it when the model cannot determine which of the trajectories the UE is going to take. If the model can, then the model provides just one trajectory, otherwise the model gives the forked options to the consumer of the predictions. The consumer may determine, using the machine learning model, a first trajectory confidence the user equipment follows a first trajectory, using one of at least one second vector of confidences, determine, using the machine learning model, a second trajectory confidence the user equipment follows a second trajectory, using another one of the at least one second vector of confidences, compare the first trajectory confidence to the second trajectory confidence, and predict the next location of the user equipment associated with the larger of the first trajectory confidence and the second trajectory confidence, if the consumer so chooses, i.e., to “flatten” again the prediction by choosing the trajectory with the highest confidence, that being up to the consumer. A higher trajectory confidence does not necessarily mean that the UE is more likely to take that fork, because it may be simply because the next steps after the forking can be more confidently predicted for that fork if the UE takes it, but that does not mean that it is more likely to take the fork.

### Information Elements (IEs) for Forking Trajectory Predictions

Table 3, shown in FIG. 10, shows configurable parameters would be added to the TrajectoryPredictionFunction.

### Information Elements for Representing Trajectory Predictions

FIG. 11 depicts example IEs that the TrajetoryPredictionFunction may use to provide the forked trajectory predictions. FIG. 11 is shown as a class diagram 1100 using the unified modeling language (UML). Shown is a TrajectoryPrediction IE 1110 that includes attributes predictionConf 1111, trajectoryList 1112 and trajectoryTree 1113. The Trajectory IE 1120 includes attributes locationIDList 1121 and trajectoryConf 1122. The TrajectoryNode IE 1130 includes a locationID 1131, previous 1132, next 1133, and a nextConfList 1134.

As further shown in FIG. 11, the trajectory prediction information element 1110 is composed of a trajectory information element 1120. There are one or more trajectory list information elements 1112. The trajectory node information element 1130 is composed of zero to one previous trajectory node information elements 1130. There are zero or more next elements 1133, and zero to one trajectory trees 1113.

### TrajectoryPrediction IE

The TrajectoryPrediction IE 1110 is an IE containing the complete trajectory prediction. It may include a list 1112 of Trajectory IEs, representing all possible trajectories taking the forking into account. Additionally, it may include a tree data structure 1113 of TrajectoryNodes 1130 for representing the complete predicted trajectory including the forking. Table 4, shown in FIG. 12, lists the attributes of an example TrajectoryPrediction IE 1110.

### Trajectory IE

Described herein is an IE representing a single trajectory, namely trajectory IE 1120. Table 5, shown in FIG. 13, lists attributes of an example trajectory IE 1120.

### TrajectoryNode IE

A tree node, e.g. TrajectoryNode IE 1130, representing one location in a trajectory is shown in FIG. 14.

### Deployment and Signaling Aspects, Example Technical Effect

The following two methods could be considered depending on where the trajectory prediction algorithm is located for inference, namely 1) a method for inference at the gNB and 2) a method for inference at a near-real-time RIC.

1. For inference at a gNB (e.g. RAN node 170), the list of trajectory predictions for the UEs could be used to support a decision mechanism at the source and the target gNBs. The source gNB may use the predicted trajectory forks to optimize, for example, its mobility (e.g. CHO preparation), load balancing or energy saving decisions. With reference to FIG. 15, the source gNB 170 can share predicted trajectory information including fork confidence levels with the target gNB 170-2 with a handover request message. The target gNB 170-2 can use this information for preparation of the cells. For example, only if the confidence level of fork 1 is higher than a threshold (set by the target gNB 170-2 itself), does the target gNB 170-2 prepare the cells on fork 1 for the UE 110.

2. For inference at a near-real-time RIC (e.g. module 150-1, module 150-2, module 177, or computer program code 173), the prediction may be used in a number of use cases in the near-RT RIC, such as energy saving, mobility optimization, or load balancing.

In the herein described solution, forking is done at the inference phase and does not require specific training. The trajectory prediction LSTM RNN may be trained, for example, in the OAM of e.g. the one or more network elements 190.

FIG. 15 shows an example 1000 of using the predicted trajectory forks for optimizing CHO preparation. The new or updated steps compared to message 3GPP TS 38.300 are given as item 1502 (Trajectory prediction), item 1503 (CHO decision), item 1504-1 (HANDOVER REQUEST), item 1504-2 (HANDOVER REQUEST), item 1505-1 (Admission Control), and item 1505-2 (Admission Control).

The trajectory prediction 1502 may be triggered by an existing event (e.g. A3) or a new event. The predicted trajectory may include several forks. The predicted trajectory forks may be used to determine at 1503 which target cells to configure for a CHO. In this example 100, cells in two target gNBs (170-2, one of 170-3) are predicted to be the potential target cell and prepared for a CHO. The predicted trajectories may be shared in the handover request (1504-1, 1504-2) to the target gNBs (170-2, 170-3) using the TrajectoryPrediction IE 1110. The shared trajectories may be only to ones relevant to that gNB. The target gNBs (170-2, 170-3) may use the predicted trajectories to optimize their admission control (1505-1, 1505-2), contention-free random access (CFRA) procedures, resource allocation etc.

Accordingly, FIG. 15 shows a signaling diagram 1000 to implement confidence-based advanced trajectory prediction based on the examples described herein. Signaling diagram 1500 comprises handover preparation 1550, handover execution 1552, and handover completion 1554. Handover preparation 1550 comprises items 1562, 1564, 1500, 1501, 1502, 1503, 1504-1, 1504-2, 1505-1, 1505-2, 1506-1, 1506-2, 1507, and 1508. Handover execution 1552 comprises items 1508-a, 1566, 1568, 1570, and 1509. Handover completion 1554 comprises items 1509-a, 1509-b, 1572, 1509-3, and 1574.

At 1562, user data is exchanged between UE 110 and source gNB 170. At 1564, user data is exchanged between source gNB 170 and UPF 190-2. At 1500, the AMF 190-1 provides mobility control information to the source gNB 170, the target gNB 170-2, and the other one or more potential target gNB(s) 170-3. At 1501, measurement control and reporting is performed by UE 110 and source gNB 170.

At 1502, the source gNB 170 performs trajectory prediction. At 1503, the source gNB 170 makes a CHO decision, which may be partially based on the trajectory prediction 1502. At 1504-1, the source gNB 170 transmits a handover request to the target gNB 170-2. At 1504-2, the source gNB 170 transmits a handover request to the one or more other potential target gNB(s) 170-3. At 1505-1, the target gNB 170-2 performs admission control, and at 1505-2, one or more of the other potential target gNB(s) 170-3 performs admission control.

At 1506-1, the target gNB 170-2 transmits to the source gNB 170 a handover request acknowledgement, and at 1506-2, the one or more other potential target gNB(s) 170-3 transmits a handover request acknowledgement to the source gNB 170. At 1507, the source gNB 170 transmits an RRC reconfiguration message to the UE 110, and at 1508, the UE 110 transmits an RRC reconfiguration complete message to the source gNB 170.

At 1508-a, the source gNB 170 transmits an early status transfer message to the other potential target gNB(s) 170-3. At 1566, the UE 110 evaluates the CHO conditions. At 1568, the UE 110 detaches from the old cell, and synchronizes to the new cell. At 1570, user data is transmitted from the UPF(s) 190-2 to the source gNB 170, and then user data is transmitted from the source gNB 170 to the other potential target gNB(s) 170-3. At 1509, the UE 110, the source gNB 170, and the target gNB 170-2 perform CHO handover completion.

At 1509-a, the target gNB 170-2 transmits a handover success message to the source gNB 170, and at 1509-b, the source gNB 170 transmits an SN status transfer message to the target gNB 170-2. At 1572, user data is transmitted from the one or more UPF(s) 190-2 to the source gNB 170, and then user data is transmitted from the source gNB 170 to the target gNB 170-2. At 1509-3, the source gNB 170 transmits a handover cancel message to the target gNB 170-2 and the other potential target gNB(s) 170-3. At 1574, the UE 110, source gNB 170, target gNB 170-2, the one or more other potential target gNB(s) 170-3, AMF 190-1, and the one or more UPF(s) 190-2 perform steps 9-12 of 3GPP TS 38.300 FIG. 9.2.3.2.1-1.

There are several technical effects and advantages of the examples described herein. With the solution described herein, it is possible for trajectory prediction to better capture UE mobility behavior, where often there can be several optional trajectories that a UE can take but predicting which one may not be possible. A vehicular UE in an intersection is such an example. A trajectory prediction predicting only one trajectory may give a wrong prediction, which can have significant impact on performance of functions utilizing the prediction. On the other hand, it can be predicted that a UE takes one of the possible trajectories, which is very important information. Accordingly, described herein is a method for making such forking trajectory predictions as well as the configuring of the method and the information elements for presenting the forking trajectory predictions.

A further advantage of examples described herein is in use cases that can utilize multiple possible and likely future trajectories, for example to reserve resources up front, which are either committed or released depending on if the UE takes that path or not. Examples of such are conditional handover and beam selection optimization.

The examples described herein impact the X2/Xn interfaces, including those described within the TR 37.817, TS 36.423, and TS 38.423 specifications by the indicated IEs that are subject to standards impact and discussions.

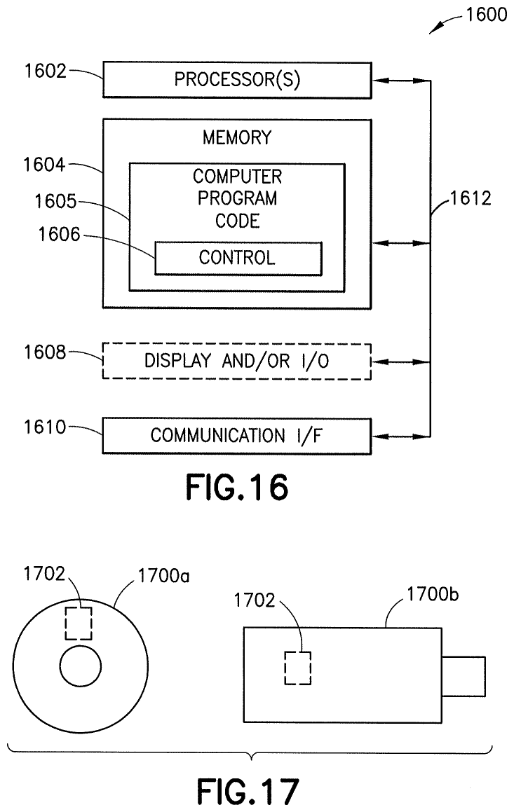

FIG. 16 is an example apparatus 1600, which may be implemented in hardware, configured to implement the examples described herein. The apparatus 1600 comprises at least one processor 1602 (e.g. an FPGA and/or CPU), at least one memory 1604 including computer program code 1605, wherein the at least one memory 1604 and the computer program code 1605 are configured to, with the at least one processor 1602, cause the apparatus 1600 to implement circuitry, a process, component, module, or function (collectively control 1606) to implement the examples described herein, including confidence-based advanced trajectory prediction. The memory 1604 may be a non-transitory memory, a transitory memory, a volatile memory (e.g. RAM), or a non-volatile memory (e.g. ROM).

The apparatus 1600 optionally includes a display and/or I/O interface 1608 that may be used to display aspects or a status of the methods described herein (e.g., as one of the methods is being performed or at a subsequent time), or to receive input from a user such as with using a keypad, camera, touchscreen, touch area, microphone, biometric recognition, etc. The apparatus 1600 includes one or more communication e.g. network (N/W) interfaces (I/F(s)) 1610. The communication I/F(s) 1610 may be wired and/or wireless and communicate over the Internet/other network(s) via any communication technique. The communication I/F(s) 1610 may comprise one or more transmitters and one or more receivers. The communication I/F(s) 1610 may comprise standard well-known components such as an amplifier, filter, frequency-converter, (de)modulator, and encoder/decoder circuitries and one or more antennas.

The apparatus 1600 to implement the functionality of control 1606 may be UE 110, RAN node 170 (e.g. gNB), or network element(s) 190. Thus, processor 1602 may correspond to processor(s) 120, processor(s) 152 and/or processor(s) 175, memory 1604 may correspond to memory(ies) 125, memory(ies) 155 and/or memory(ies) 171, computer program code 1605 may correspond to computer program code 123, module 140-1, module 140-2, and/or computer program code 153, module 150-1, module 150-2, and/or computer program code 173, and communication I/F(s) 510 may correspond to transceiver 130, antenna(s) 128, transceiver 160, antenna(s) 158, N/W I/F(s) 161, and/or N/W I/F(s) 180. Alternatively, apparatus 1600 may not correspond to either of UE 110, RAN node 170, or network element(s) 190, as apparatus 1600 may be part of a self-organizing/optimizing network (SON) node, such as in a cloud.

The apparatus 1600 may also be distributed throughout the network (e.g. 100) including within and between apparatus 1600 and any network element (such as a network control element (NCE) 190 and/or the RAN node 170 and/or the UE 110).

Interface 1612 enables data communication between the various items of apparatus 1600, as shown in FIG. 16. For example, the interface 1612 may be one or more buses such as address, data, or control buses, and may include any interconnection mechanism, such as a series of lines on a motherboard or integrated circuit, fiber optics or other optical communication equipment, and the like. Computer program code 1605, including control 1606 may comprise object-oriented software configured to pass data/messages between objects within computer program code 1605. The apparatus 1600 need not comprise each of the features mentioned, or may comprise other features as well.

FIG. 17 shows a schematic representation of non-volatile memory media 1700a (e.g. computer disc (CD) or digital versatile disc (DVD)) and 1700b (e.g. universal serial bus (USB) memory stick) storing instructions and/or parameters 1702 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described example embodiments.

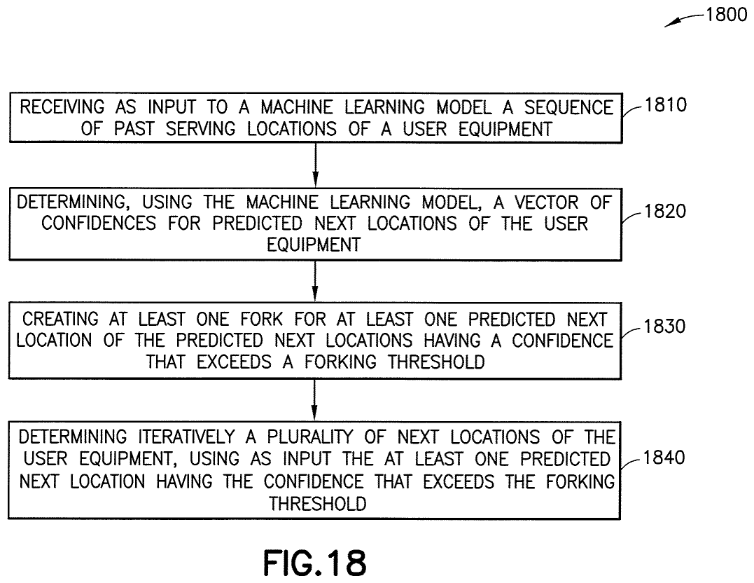

FIG. 18 is an example method 1800 to implement the example embodiments described herein. At 1810, the method includes receiving as input to a machine learning model a sequence of past serving locations of a user equipment. At 1820, the method includes determining, using the machine learning model, a vector of confidences for predicted next locations of the user equipment. At 1830, the method includes creating at least one fork for at least one predicted next location of the predicted next locations having a confidence that exceeds a forking threshold. At 1840, the method includes determining iteratively a plurality of next locations of the user equipment, using as input the at least one predicted next location having the confidence that exceeds the forking threshold. Method 1800 may be performed with a network node (e.g. RAN node 170, source gNB 170).

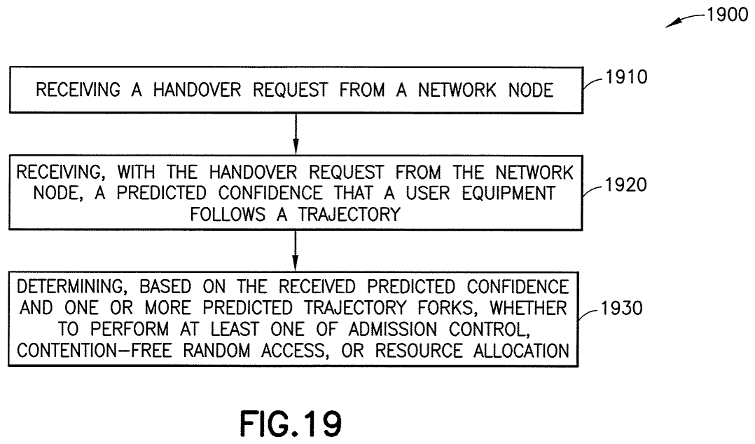

FIG. 19 is an example method 1900 to implement the example embodiments described herein. At 1910, the method includes receiving a handover request from a network node. At 1920, the method includes receiving, with the handover request from the network node, a predicted confidence that a user equipment follows a trajectory. At 1930, the method includes determining, based on the received predicted confidence and one or more predicted trajectory forks, whether to perform at least one of admission control, contention-free random access, or resource allocation. Method 1900 may be performed with a network node (e.g. RAN node 170, target node 170-2, or the other potential target gNB(s) 170-3).

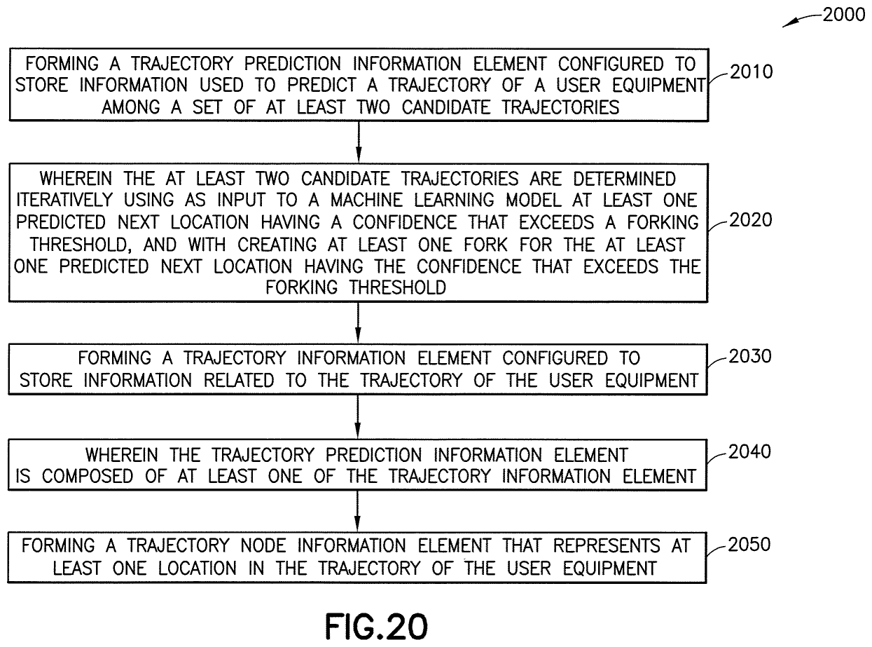

FIG. 20 is an example method 2000 to implement the example embodiments described herein. At 2010, the method includes forming a trajectory prediction information element configured to store information used to predict a trajectory of a user equipment among a set of at least two candidate trajectories. At 2020, the method includes wherein the at least two candidate trajectories are determined iteratively using as input to a machine learning model at least one predicted next location having a confidence that exceeds a forking threshold, and with creating at least one fork for the at least one predicted next location having the confidence that exceeds the forking threshold. At 2030, the method includes forming a trajectory information element configured to store information related to the trajectory of the user equipment. At 2040, the method includes wherein the trajectory prediction information element is composed of at least one of the trajectory information element. At 2050, the method includes forming a trajectory node information element that represents at least one location in the trajectory of the user equipment. Method 2000 may be performed with a network node (e.g. RAN node 170, source gNB 170).

The following examples (1-30) are provided and described herein.

Example 1. An apparatus including: at least one processor; and at least one memory including computer program code; wherein the at least one memory and the computer program code are configured to, with the at least one processor, cause the apparatus at least to: receive as input to a machine learning model a sequence of past serving locations of a user equipment; determine, using the machine learning model, a vector of confidences for predicted next locations of the user equipment; create at least one fork for at least one predicted next location of the predicted next locations having a confidence that exceeds a forking threshold; and determine iteratively a plurality of next locations of the user equipment, using as input the at least one predicted next location having the confidence that exceeds the forking threshold.

Example 2. The apparatus of example 1, wherein the at least one memory and the computer program code are configured to, with the at least one processor, cause the apparatus at least to: determine, using the machine learning model, at least one second vector of confidences for candidate next locations of the user equipment, using as input the at least one predicted next location having the confidence that exceeds the forking threshold; wherein the plurality of next locations are determined using as input the at least one second vector of confidences for candidate next locations of the user equipment.

Example 3. The apparatus of example 2, wherein the sequence of past locations, the predicted next locations, and the candidate next locations include serving beams, serving cells, location pixels, or location quanta.

Example 4. The apparatus of any of examples 2 to 3, wherein the at least one memory and the computer program code are configured to, with the at least one processor, cause the apparatus at least to: predict at least one next location for the user equipment of the plurality of next locations, based partially on the at least one second vector of confidences.

Example 5. The apparatus of example 1, wherein a first one of the predicted next locations is determined to include a first confidence, and wherein a second one of the predicted next locations is determined to include a second confidence; wherein a first one of the candidate next locations is determined to include a third confidence, using as input the first one of the predicted next locations; wherein a second one of the candidate next locations is determined to include a fourth confidence, using as input the second one of the predicted next locations; wherein a first trajectory confidence is determined with multiplying the first confidence and the third confidence, and a second trajectory confidence is determined with multiplying the second confidence with the fourth confidence.

Example 6. The apparatus of example 5, wherein the at least one memory and the computer program code are configured to, with the at least one processor, cause the apparatus at least to: determine a fork confidence that the user equipment follows a first trajectory or a second trajectory, based on the first trajectory confidence and the second trajectory confidence.

Example 7. The apparatus of any of examples 1 to 6, wherein the at least one memory and the computer program code are configured to, with the at least one processor, cause the apparatus at least to: determine at least one confidence corresponding to at least one candidate next location of the at least one second vector of confidences for the candidate next locations; compare the at least one confidence corresponding to the at least one candidate next location to the forking threshold; and create at least one fork for the at least one candidate next location, in response to the at least one confidence corresponding to at least one candidate next location exceeding the forking threshold.

Example 8. The apparatus of example 7, wherein the at least one memory and the computer program code are configured to, with the at least one processor, cause the apparatus at least to: determine, using the machine learning model, a first trajectory confidence the user equipment follows a first trajectory, based on one of the at least one fork for the at least one candidate next location; and determine, using the machine learning model, a second trajectory confidence the user equipment follows a second trajectory, based on another one of the at least one fork for the at least one candidate next location.

Example 9. The apparatus of example 8, wherein the at least one memory and the computer program code are configured to, with the at least one processor, cause the apparatus to: determine a first fork confidence that the user equipment follows the first trajectory using at least the first trajectory confidence; and determine a second fork confidence that the user equipment follows the second trajectory using at least the second trajectory confidence.

Example 10. The apparatus of example 9, wherein the at least one memory and the computer program code are configured to, with the at least one processor, cause the apparatus to: determine a cumulative fork confidence the user equipment follows the first trajectory or the second trajectory using the first fork confidence and the second fork confidence.

Example 11. The apparatus of any of examples 2 to 10, wherein the at least one memory and the computer program code are configured to, with the at least one processor, cause the apparatus to: determine, using the machine learning model, a trajectory confidence the user equipment follows a trajectory, using one of the at least one second vector of confidences; compare the trajectory confidence to a second forking threshold; determine to create an additional fork for one of the candidate locations, in response to the trajectory confidence being above the second forking threshold; and determine not to create the additional fork for the one of the candidate locations, in response to the trajectory confidence being below the second forking threshold.

Example 12. The apparatus of any of examples 1 to 11, wherein the at least one memory and the computer program code are configured to, with the at least one processor, cause the apparatus to: determine to create at least one fork for one of the candidate next locations, in response to a number of created forks being less than a prediction window threshold; and determine not to create the at least one fork for the one of the candidate next locations, in response to the number of created forks being greater than or equal to the prediction window threshold.

Example 13. The apparatus of any of examples 1 to 12, wherein the machine learning model includes a long short-term memory recurrent neural network.

Example 14. The apparatus of any of examples 2 to 13, wherein the at least one memory and the computer program code are configured to, with the at least one processor, cause the apparatus at least to: predict one or more possible series of next serving beams for the user equipment, based at least partially on the vector of confidences or the second vector of confidences; and transmit a request to prepare a conditional handover to network nodes hosting the predicted potential next serving beams in the one or more series of next serving beams.

Example 15. The apparatus of any of examples 5 to 14, wherein the at least one memory and the computer program code are configured to, with the at least one processor, cause the apparatus at least to: transmit a first handover request to a first network node associated with a first candidate target cell, in response to the first trajectory confidence exceeding a first threshold; and transmit a second handover request second network node associated with a second candidate target cell, in response to the second trajectory confidence exceeding a second threshold; wherein the user equipment selects one of the first candidate target cell or the second candidate target cell, based on at least one measurement and a configured conditional handover condition.

Example 16. An apparatus including: at least one processor; and at least one memory including computer program code; wherein the at least one memory and the computer program code are configured to, with the at least one processor, cause the apparatus at least to: receive a handover request from a network node; receive, with the handover request from the network node, a predicted confidence that a user equipment follows a trajectory; and determine, based on the received predicted confidence and one or more predicted trajectory forks, whether to perform at least one of admission control, contention-free random access, or resource allocation.

Example 17. The apparatus of example 16, wherein the at least one memory and the computer program code are configured to, with the at least one processor, cause the apparatus at least to: receive, with the handover request from the network node, a second predicted confidence that the user equipment follows a second trajectory; compare the predicted confidence that a user equipment follows the trajectory to the second predicted confidence that the user equipment follows the second trajectory; and determine, based on the comparison, whether to perform at least one of admission control, contention-free random access, or resource allocation.

Example 18. An apparatus including: at least one processor; and at least one memory including computer program code; wherein the at least one memory and the computer program code are configured to, with the at least one processor, cause the apparatus at least to: form a trajectory prediction information element configured to store information used to predict a trajectory of a user equipment among a set of at least two candidate trajectories; wherein the at least two candidate trajectories are determined iteratively using as input to a machine learning model at least one predicted next location having a confidence that exceeds a forking threshold, and with creating at least one fork for the at least one predicted next location having the confidence that exceeds the forking threshold; form a trajectory information element configured to store information related to the trajectory of the user equipment; wherein the trajectory prediction information element is composed of at least one of the trajectory information element; and form a trajectory node information element that represents at least one location in the trajectory of the user equipment.

Example 19. The apparatus of example 18, wherein the trajectory prediction information element includes: a prediction confidence of the predicted trajectory of the user equipment; a list of predicted trajectories; and a trajectory tree that stores prediction forks as a tree structure, the tree structure used to predict the trajectory of the user equipment.

Example 20. The apparatus of any of examples 18 to 19, wherein the trajectory information element includes: a list of location identifiers in order of the trajectory of the user equipment, wherein the location identifiers include a beam identifier, a cell identifier, or a user equipment coordinate; and a trajectory confidence of the predicted trajectory of the user equipment.

Example 21. The apparatus of any of examples 18 to 20, wherein the trajectory node information element includes: a pointer to a previous trajectory node information element; a list of pointers to a plurality of trajectory nodes in the prediction of the trajectory of the user equipment; and a list of confidences for the plurality of trajectory nodes, stored in an order corresponding to an order of the list of pointers.

Example 22. A method including: receiving as input to a machine learning model a sequence of past serving locations of a user equipment; determining, using the machine learning model, a vector of confidences for predicted next locations of the user equipment; creating at least one fork for at least one predicted next location of the predicted next locations having a confidence that exceeds a forking threshold; and determining iteratively a plurality of next locations of the user equipment, using as input the at least one predicted next location having the confidence that exceeds the forking threshold.

Example 23. A method including: receiving a handover request from a network node; receiving, with the handover request from the network node, a predicted confidence that a user equipment follows a trajectory; and determining, based on the received predicted confidence and one or more predicted trajectory forks, whether to perform at least one of admission control, contention-free random access, or resource allocation.

Example 24. A method including: forming a trajectory prediction information element configured to store information used to predict a trajectory of a user equipment among a set of at least two candidate trajectories; wherein the at least two candidate trajectories are determined iteratively using as input to a machine learning model at least one predicted next location having a confidence that exceeds a forking threshold, and with creating at least one fork for the at least one predicted next location having the confidence that exceeds the forking threshold; forming a trajectory information element configured to store information related to the trajectory of the user equipment; wherein the trajectory prediction information element is composed of at least one of the trajectory information element; and forming a trajectory node information element that represents at least one location in the trajectory of the user equipment.

Example 25. An apparatus including: means for receiving as input to a machine learning model a sequence of past serving locations of a user equipment; means for determining, using the machine learning model, a vector of confidences for predicted next locations of the user equipment; means for creating at least one fork for at least one predicted next location of the predicted next locations having a confidence that exceeds a forking threshold; and means for determining iteratively a plurality of next locations of the user equipment, using as input the at least one predicted next location having the confidence that exceeds the forking threshold.

Example 26. An apparatus including: means for receiving a handover request from a network node; means for receiving, with the handover request from the network node, a predicted confidence that a user equipment follows a trajectory; and means for determining, based on the received predicted confidence and one or more predicted trajectory forks, whether to perform at least one of admission control, contention-free random access, or resource allocation.

Example 27. An apparatus including: means for forming a trajectory prediction information element configured to store information used to predict a trajectory of a user equipment among a set of at least two candidate trajectories; wherein the at least two candidate trajectories are determined iteratively using as input to a machine learning model at least one predicted next location having a confidence that exceeds a forking threshold, and with creating at least one fork for the at least one predicted next location having the confidence that exceeds the forking threshold; means for forming a trajectory information element configured to store information related to the trajectory of the user equipment; wherein the trajectory prediction information element is composed of at least one of the trajectory information element; and means for forming a trajectory node information element that represents at least one location in the trajectory of the user equipment.

Example 28. A non-transitory program storage device readable by a machine, tangibly embodying a program of instructions executable with the machine for performing operations, the operations including: receiving as input to a machine learning model a sequence of past serving locations of a user equipment; determining, using the machine learning model, a vector of confidences for predicted next locations of the user equipment; creating at least one fork for at least one predicted next location of the predicted next locations having a confidence that exceeds a forking threshold; and determining iteratively a plurality of next locations of the user equipment, using as input the at least one predicted next location having the confidence that exceeds the forking threshold.

Example 29. A non-transitory program storage device readable by a machine, tangibly embodying a program of instructions executable with the machine for performing operations, the operations including: receiving a handover request from a network node; receiving, with the handover request from the network node, a predicted confidence that a user equipment follows a trajectory; and determining, based on the received predicted confidence and one or more predicted trajectory forks, whether to perform at least one of admission control, contention-free random access, or resource allocation.

Example 30. A non-transitory program storage device readable by a machine, tangibly embodying a program of instructions executable with the machine for performing operations, the operations including: forming a trajectory prediction information element configured to store information used to predict a trajectory of a user equipment among a set of at least two candidate trajectories; wherein the at least two candidate trajectories are determined iteratively using as input to a machine learning model at least one predicted next location having a confidence that exceeds a forking threshold, and with creating at least one fork for the at least one predicted next location having the confidence that exceeds the forking threshold; forming a trajectory information element configured to store information related to the trajectory of the user equipment; wherein the trajectory prediction information element is composed of at least one of the trajectory information element; and forming a trajectory node information element that represents at least one location in the trajectory of the user equipment.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash or hyphen):
3GPP third generation partnership project
4G fourth generation
5G fifth generation
5GC 5G core network
A3 triggered when a neighboring cell becomes better than a serving cell by an offset
AMF access and mobility management function
ASIC application-specific integrated circuit
CBRA contention-based random access
C_{F} fork confidence
CFRA contention-free random access
CHO conditional handover
Conf confidence
CPU central processing unit
CT trajectory confidence
CU central unit or centralized unit
DSP digital signal processor
DU distributed unit
eNB evolved Node B (e.g., an LTE base station)
EN-DC E-UTRAN new radio—dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FPGA field-programmable gate array
gNB base station for 5G/NR, i.e., a node providing NR user plane and control plane protocol terminations towards the UE, and connected via the NG interface to the 5GC
IAB integrated access and backhaul
ID identifier
IE information element
I/F interface
I/O input/output
L1 layer 1
L2 layer 2
L3 layer 3
LMF location management function
LSTM long-short term memory
LTE long term evolution (4G)
M mandatory
MAC medium access control
ML machine learning
MME mobility management entity
MRM multi-RAT mobility
MRO mobility robustness optimization
NCE network control element
ng or NG new generation
ng-eNB new generation eNB
NG-RAN new generation radio access network
NLP natural language processing
NR new radio (5G)
N/W network
O optional
OAM operations, administration, and maintenance
PDA personal digital assistant
PDCP packet data convergence protocol
PHY physical layer
RAM random access memory
RAN radio access network
RAN3 RAN meeting
Rel-release
RIC RAN intelligent controller
RLC radio link control
RNN recurrent neural network
ROM read-only memory
RRC radio resource control (protocol)
RRH remote radio head
RSRP reference signal received power
RT real time
RU radio unit
Rx receiver or reception
SDAP service data adaption protocol
SGW serving gateway
SI study item
SMF session management function
SN secondary node
SON self-organizing/optimizing network
T1 recorded trajectory
T2p predicted trajectory
TRP transmission and/or reception point
TS technical specification
TSG technical specification group
Tx transmitter or transmission
UAV unmanned aerial vehicle
UE user equipment (e.g., a wireless, typically mobile device)
UML Unified Modeling Language
UPF user plane function
WG working group
WI work item
X2 network interface between RAN nodes and between RAN and the core network
Xn network interface between NG-RAN nodes

1.-30. (canceled)

31. An apparatus comprising:
at least one processor; and
at least one memory including computer program code;
wherein the at least one memory and the computer program code are configured to, with the at least one processor, cause the apparatus at least to:
receive as input to a machine learning model a sequence of past serving locations of a user equipment;
determine, using the machine learning model, a vector of confidences for predicted next locations of the user equipment;
create at least one fork for at least one predicted next location of the predicted next locations having a confidence that exceeds a forking threshold;
determine iteratively a plurality of next locations of the user equipment, using as input the at least one predicted next location having the confidence that exceeds the forking threshold, wherein the plurality of next locations are determined using as input the at least one second vector of confidences for candidate next locations of the user equipment;
determine, using the machine learning model, at least one second vector of confidences for candidate next locations of the user equipment, using as input the at least one predicted next location having the confidence that exceeds the forking threshold;
wherein a first one of the predicted next locations is determined to comprise a first confidence, and wherein a second one of the predicted next locations is determined to comprise a second confidence;
wherein a first one of the candidate next locations is determined to comprise a third confidence, using as input the first one of the predicted next locations;
wherein a second one of the candidate next locations is determined to comprise a fourth confidence, using as input the second one of the predicted next locations;
determine a first trajectory confidence by multiplying the first confidence and the third confidence;
determine a second trajectory confidence by multiplying the second confidence with the fourth confidence;
determine a first fork confidence that the user equipment follows the first trajectory using at least the first trajectory confidence;
determine a second fork confidence that the user equipment follows the second trajectory using at least the second trajectory confidence;
determine a cumulative fork confidence the user equipment follows the first trajectory or the second trajectory using the first fork confidence and the second fork confidence;
determine, using the machine learning model, a third trajectory confidence the user equipment follows a third trajectory, using one of the at least one second vector of confidences;
compare the trajectory confidence to a second forking threshold;
determine to create an additional fork for one of the candidate locations, in response to the trajectory confidence being above the second forking threshold; and
determine not to create the additional fork for the one of the candidate locations, in response to the trajectory confidence being below the second forking threshold.

32. The apparatus of claim 31, wherein the sequence of past locations, the predicted next locations, and the candidate next locations comprise serving beams, serving cells, location pixels, or location quanta.

33. The apparatus of claim 32, wherein the at least one memory and the computer program code are configured to, with the at least one processor, cause the apparatus at least to:
predict at least one next location for the user equipment of the plurality of next locations, based partially on the at least one second vector of confidences.

34. The apparatus of claim 33, wherein the at least one memory and the computer program code are configured to, with the at least one processor, cause the apparatus at least to:
determine at least one confidence corresponding to at least one candidate next location of the at least one second vector of confidences for the candidate next locations;
compare the at least one confidence corresponding to the at least one candidate next location to the forking threshold; and
create at least one fork for the at least one candidate next location, in response to the at least one confidence corresponding to at least one candidate next location exceeding the forking threshold.

35. The apparatus of claim 34, wherein the at least one memory and the computer program code are configured to, with the at least one processor, cause the apparatus to:
determine to create at least one fork for one of the candidate next locations, in response to a number of created forks being less than a prediction window threshold; and
determine not to create the at least one fork for the one of the candidate next locations, in response to the number of created forks being greater than or equal to the prediction window threshold.

36. The apparatus of claim 35, wherein the machine learning model comprises a long short-term memory recurrent neural network.

37. The apparatus of claim 36, wherein the at least one memory and the computer program code are configured to, with the at least one processor, cause the apparatus at least to:
predict one or more possible series of next serving beams for the user equipment, based at least partially on the vector of confidences or the second vector of confidences; and
transmit a request to prepare a conditional handover to network nodes hosting the predicted potential next serving beams in the one or more series of next serving beams.

38. The apparatus of claim 37, wherein the at least one memory and the computer program code are configured to, with the at least one processor, cause the apparatus at least to:
transmit a first handover request to a first network node associated with a first candidate target cell, in response to the first trajectory confidence exceeding a first threshold; and
transmit a second handover request second network node associated with a second candidate target cell, in response to the second trajectory confidence exceeding a second threshold;
wherein the user equipment selects one of the first candidate target cell or the second candidate target cell, based on at least one measurement and a configured conditional handover condition.

39. A system comprising:
an apparatus;
at least one processor; and
at least one memory including computer program code;
wherein the at least one memory and the computer program code are configured to, with the at least one processor, cause the apparatus at least to:
receive as input to a machine learning model a sequence of past serving locations of a user equipment;
determine, using the machine learning model, a vector of confidences for predicted next locations of the user equipment;
create at least one fork for at least one predicted next location of the predicted next locations having a confidence that exceeds a forking threshold;
determine iteratively a plurality of next locations of the user equipment, using as input the at least one predicted next location having the confidence that exceeds the forking threshold, wherein the plurality of next locations are determined using as input the at least one second vector of confidences for candidate next locations of the user equipment;
determine, using the machine learning model, at least one second vector of confidences for candidate next locations of the user equipment, using as input the at least one predicted next location having the confidence that exceeds the forking threshold;
wherein a first one of the predicted next locations is determined to comprise a first confidence, and wherein a second one of the predicted next locations is determined to comprise a second confidence;
wherein a first one of the candidate next locations is determined to comprise a third confidence, using as input the first one of the predicted next locations;
wherein a second one of the candidate next locations is determined to comprise a fourth confidence, using as input the second one of the predicted next locations;
determine a first trajectory confidence by multiplying the first confidence and the third confidence;
determine a second trajectory confidence by multiplying the second confidence with the fourth confidence;
determine a first fork confidence that the user equipment follows the first trajectory using at least the first trajectory confidence;
determine a second fork confidence that the user equipment follows the second trajectory using at least the second trajectory confidence;
determine a cumulative fork confidence the user equipment follows the first trajectory or the second trajectory using the first fork confidence and the second fork confidence;
determine, using the machine learning model, a third trajectory confidence the user equipment follows a third trajectory, using one of the at least one second vector of confidences;
compare the trajectory confidence to a second forking threshold;
determine to create an additional fork for one of the candidate locations, in response to the trajectory confidence being above the second forking threshold; and
determine not to create the additional fork for the one of the candidate locations, in response to the trajectory confidence being below the second forking threshold.

40. The system of claim 39, wherein the sequence of past locations, the predicted next locations, and the candidate next locations comprise serving beams, serving cells, location pixels, or location quanta.

41. The system of claim 40, wherein the at least one memory and the computer program code are configured to, with the at least one processor, cause the apparatus at least to:
predict at least one next location for the user equipment of the plurality of next locations, based partially on the at least one second vector of confidences.

42. The system of claim 41, wherein the at least one memory and the computer program code are configured to, with the at least one processor, cause the apparatus at least to:
determine at least one confidence corresponding to at least one candidate next location of the at least one second vector of confidences for the candidate next locations;
compare the at least one confidence corresponding to the at least one candidate next location to the forking threshold; and
create at least one fork for the at least one candidate next location, in response to the at least one confidence corresponding to at least one candidate next location exceeding the forking threshold.

43. The system of claim 42, wherein the at least one memory and the computer program code are configured to, with the at least one processor, cause the apparatus to:
determine to create at least one fork for one of the candidate next locations, in response to a number of created forks being less than a prediction window threshold; and
determine not to create the at least one fork for the one of the candidate next locations, in response to the number of created forks being greater than or equal to the prediction window threshold.

44. The system of claim 43, wherein the machine learning model comprises a long short-term memory recurrent neural network.

45. The system of claim 44, wherein the at least one memory and the computer program code are configured to, with the at least one processor, cause the apparatus at least to:
predict one or more possible series of next serving beams for the user equipment, based at least partially on the vector of confidences or the second vector of confidences; and
transmit a request to prepare a conditional handover to network nodes hosting the predicted potential next serving beams in the one or more series of next serving beams.

46. The system of claim 45, wherein the at least one memory and the computer program code are configured to, with the at least one processor, cause the apparatus at least to:
transmit a first handover request to a first network node associated with a first candidate target cell, in response to the first trajectory confidence exceeding a first threshold; and
transmit a second handover request second network node associated with a second candidate target cell, in response to the second trajectory confidence exceeding a second threshold;
wherein the user equipment selects one of the first candidate target cell or the second candidate target cell, based on at least one measurement and a configured conditional handover condition.
